(19) United States
(12) Patent Application Publication
(10) Pub. No.: US 2013/0307701 A1
(43) Pub. Date: Nov. 21, 2013

(54) Wirelessly Networked Fluid Monitoring Method, System and Apparatus

(71) Applicant: Andrew Forster-Knight, Oak Park (AU)

(72) Inventor: Andrew Forster-Knight, Oak Park (AU)

(73) Assignee: South East Water Corporation, Heatherton, Victoria (AU)

(21) Appl. No.: 13/824,023

(22) PCT Filed: Feb. 9, 2012
(86) PCT No.: PCT/AU12/00116

§ 371 Date: Jul. 5, 2013

(30) Foreign Application Priority Data
Feb. 9, 2011 (AU) 2011900421

(51) Int. Cl. G01D 4/00

(52) U.S. Cl. CPC G01D 4/002
USPC 340/870.02

(57) ABSTRACT

Some embodiments relate to a fluid monitoring system, comprising: a housing positioned in-ground above a buried fluid conduit, the housing having a lockable access hatch to allow access to an internal volume of the housing from surface level; at least one sensor accessible through the internal volume and arranged to sense at least one condition of fluid in the fluid conduit; and a wireless telemetry unit supported in the housing and coupled to receive output signals from the at least one sensor in relation to the at least one condition. Some embodiments relate to methods usable by such systems. Some embodiments relate to fluid supply/drainage zone monitoring systems and methods employing multiple in-ground installations.

### CROSS-REFERENCE TO RELATED APPLICATIONS

The present application claims priority from Australian Provisional Patent Application 2011900421 filed on 9 Feb. 2011, the content of which is incorporated herein by reference.

### TECHNICAL FIELD

Described embodiments relate generally to wirelessly networked fluid monitoring methods, systems and apparatus. In particular, some embodiments relate to such methods, systems and apparatus comprising a sub-surface (e.g. in-ground) housing to house a wireless telemetry unit proximate a sub-surface (e.g. buried) fluid conduit and cooperating with at least one sensor to sense at least one condition of fluid in the fluid conduit.

### BACKGROUND

Domestic or industrial water supply requirements are generally met by providing water through buried (i.e. underground) fluid conduits, such as pipes, that can form part of an extensive network of such conduits. Sewerage and other waste water transport also uses such a network of conduits.

Piping used for water supply or sewerage transport purposes can develop defects over time or can be damaged by the activities of others, with the result that substantial damage may occur due to water or sewerage passing into unintended areas. For water leaks, this can also result in wastage of water as a valuable resource. In some instances, the organisation responsible for maintenance of the fluid conduits may only become aware of the damage once it has already had a deleterious effect on the environment or on existing housing or public infrastructure.

Even once the responsible organisation (i.e. the water utility and/or sewerage utility) becomes aware of a leak or other fault in the fluid conduit network, it can be difficult to pinpoint the part of the network that requires maintenance in order to fix or forestall a problem.

It is desired to address or ameliorate one or more shortcomings or disadvantages associated with existing methods, systems and apparatus for fluid monitoring in varied fluid conduits, or to at least provide a useful alternative thereto.

### SUMMARY

Some embodiments relate to a fluid monitoring system, comprising:

a housing positioned in-ground above a buried fluid conduit, the housing having a lockable access hatch to allow access to an internal volume of the housing from surface level;

at least one sensor accessible through the internal volume and arranged to sense at least one condition of fluid in the fluid conduit; and

a wireless telemetry unit supported in the housing and coupled to receive output signals from the at least one sensor in relation to the at least one condition.

The telemetry unit may be free of reliance on an external power source. The wireless telemetry unit may be arranged to wirelessly transmit data corresponding to the output signals to a remote network node.

The housing may comprise substantially non-conductive material to allow transmission of data while the access hatch is closed. The housing may comprise a bottomless bin. The housing may be formed at least predominantly of a substantially rigid plastic material. The access hatch may bar access to the internal volume when closed and locked.

The telemetry unit may be mounted to the housing adjacent a side wall of the housing.

The housing may extend at least part-way from surface level to the buried fluid conduit. The at least one sensor may be arranged to sense at least one of fluid flow, fluid pressure, noise and water quality. The at least one sensor may be arranged to sense fluid flow, fluid pressure and noise. Alternatively, the at least one sensor may be arranged to sense fluid flow, fluid pressure and water quality.

The telemetry unit may comprise a controller to control operation of the at least one sensor. The telemetry unit may be configured to periodically cause the at least one sensor to turn on, wait a configured warm-up time (where required), generate an output signal corresponding to each sensed at least one condition and then turn off. The telemetry unit may also comprise a power source to power the controller and to power the at least one sensor.

The controller may be configured to compare sensor values corresponding to the received output signals to an expected range of values for each sensor and to send an alarm message to a remote network node if the sensor values for at least one sensor fall outside the expected range for that sensor.

The telemetry unit may comprise a long-life battery as its power source. The long-life battery may have sufficient stored energy to support normal operation of the telemetry unit for several years, for example up to about five years. The at least one sensor may be configured for low power consumption.

Some embodiments relate to a fluid monitoring system usable to monitor a fluid supply and drainage zone, the system comprising:

a plurality of in-ground installations, each installation comprising a fluid monitoring system as described above; and

a server to receive data representative of sensed fluid conditions from the wireless telemetry units of respective installations via a wireless network.

The installations may be positioned within a water supply and drainage zone so that monitoring by the server of sensed fluid conditions at each installation allows identification of one or more conditions of interest within the water supply and drainage zone. The at least one sensor of at least one of the installations may be arranged to sense at least one condition of fluid that is different from the at least one condition of fluid arranged to be sensed by the at least one sensor of another of the installations. One of the installations may be positioned at each main inlet conduit of the supply and drainage zone. Some of the installations may be positioned around an outside of the supply and drainage zone and fewer of the installations may be positioned in inner areas of the supply and drainage zone.

Some further embodiments relate to a fluid monitoring system, comprising:

a plurality of sensors positioned to sense conditions of at least one buried fluid conduit;

a plurality of wireless telemetry units, each telemetry unit positioned within an in-ground housing proximate at least one of the plurality of sensors and coupled thereto to receive output signals corresponding to sensed conditions; and

a server to communicate with the wireless telemetry units via a wireless network, to receive data representative of the sensed conditions.

Each wireless telemetry unit may be free of reliance on an external power source.

The server may comprise program code to process the received data representative of the sensed conditions according to a set of stored rules accessible to the server. Processing of the received data may include accessing stored historical data received from the wireless telemetry units and determining whether an event of interest appears to be occurring or is likely to occur in relation to the at least one conduit. The server may comprise an interface component to communicate with a client device in relation to the received data representative of the sensed conditions.

Some further embodiments relate to a fluid monitoring method, comprising:

providing a wireless telemetry unit in-ground above a buried fluid conduit, the wireless telemetry unit coupled to receive output signals from at least one sensor arranged to sense at least one condition of fluid in the fluid conduit, the at least one sensor relying on power from the wireless telemetry unit;

selectively providing power from the wireless telemetry unit to the at least one sensor;

when the at least one sensor is powered, receiving at the wireless telemetry unit output signals from the at least one sensor indicative of at least one fluid condition in the fluid conduit; and

discontinuing power from the wireless telemetry unit to the at least one sensor after the receiving.

The providing power may be selected to occur at predetermined intervals. The wireless telemetry unit may be free of reliance on an external power source. In the method, the wireless telemetry unit may be positioned in an in-ground lockable housing accessible from surface level.

The method may further comprise transmitting a message from the wireless telemetry unit to a remote server, the message containing data corresponding to, derived from or otherwise based on the output signals from the at least one sensor.

The method may further comprise waiting a predetermined time between the providing power and the receiving output signals to allow the at least one sensor to become ready to provide the output signals. The method may further comprise the wireless telemetry unit processing the output signals to determine whether an alarm condition exists. The method may further comprise the wireless telemetry unit sending an alarm message to a remote network node if an alarm condition is determined to exist. The remote network node may include a server system and/or a mobile client communication device.

Some embodiments relate to a fluid monitoring method, comprising:

receiving at a server messages from a plurality of wireless telemetry units communicatively coupled to a plurality of sensors, at least one sensor coupled to each wireless telemetry unit being positioned to sense a condition of at least one buried fluid conduit, the messages comprising data indicative of one or more of the sensed conditions; and

processing the message data to infer trends and/or determine an event of interest in relation to the at least one buried fluid conduit.

The method may further comprise:

processing the message data to determine whether an alarm, fault or special condition is indicated in relation to one or more conditions of the at least one buried fluid conduit;

transmitting a notification message to at least one predetermined notification recipient if the server determines that an alarm, fault or special condition is indicated.

The event of interest may comprise a fluid theft or a fluid leak, for example.

### BRIEF DESCRIPTION OF THE DRAWINGS

Embodiments are described in further detail below, by way of example, with reference to the accompanying drawings, in which:

FIG. 1 is a schematic representation of apparatus for fluid monitoring;

FIG. 2 is a block diagram showing a telemetry unit in further detail;

FIG. 3 is a block diagram of a wirelessly networked fluid monitoring system according to some embodiments;

FIG. 4 is a flowchart of a method of fluid monitoring employed by the 10 telemetry unit;

FIG. 5 is an example plot of pressure sensed at a number of different locations in a fluid conduit network, illustrating variations in sensed fluid pressure over time;

FIG. 6 is an example display of the fluid pressure sensors plotted in FIG. 5, overlaid on a geographic image to indicate their locations; and

FIG. 7 is a flowchart of a method of fluid monitoring using one or more of the wirelessly networked fluid monitoring apparatus of FIG. 1.

### DETAILED DESCRIPTION

Described embodiments relate generally to wirelessly networked fluid monitoring methods, systems, installations and apparatus. In particular, some embodiments relate to such methods, systems, installations and apparatus comprising a sub-surface (e.g. in-ground) housing to house a wireless telemetry unit proximate a sub-surface (e.g. buried) fluid conduit and cooperating with at least one sensor to sense at least one condition of fluid in the fluid conduit. Data from the sensed conditions can then be used to automatically generate alarms or other notifications, for example.

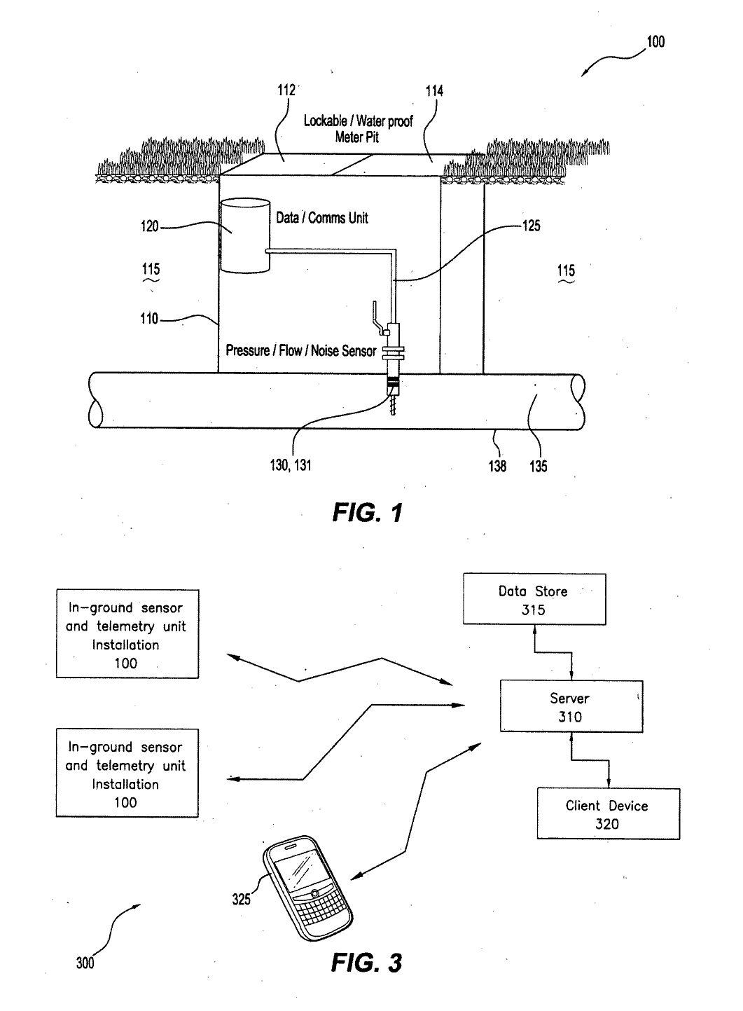

Referring in particular to FIG. 1, there is shown an installation 100 comprising a housing 110 positioned in ground 115 and extending downwardly from ground level to a level at or above a buried fluid conduit 135. At its uppermost extent, housing 110 is preferably positioned to be substantially flush with, or slightly sunken relative to, ground level.

Housing 110 houses a wireless telemetry unit 120 for monitoring at least one condition of fluid in the conduit 135 using one or more sensors 130, 131. The one or more sensors 130, 131 are electrically and communicatively coupled to the telemetry unit 120 via a suitable cable 125, which may contain separate power and signalling conduits. The one or more sensors 130, 131 rely on the provision of power from telemetry unit 120 via cable 125 in order to function. Telemetry unit 120 only turns on power to the one or more sensors 130, 131 when it is desired to take a sensor reading in relation to fluid conditions in the conduit 135, and the telemetry unit 120 removes power from the one or more sensors 130, 131 at other times. Commercially available sensors may be used as sensors 130, 131, but modified as necessary to operate at low power under the control of telemetry unit 120.

In some embodiments, installation 100 may be positioned within sub-surface structures other than soil. However, for convenient reference, the installation 100 will be described herein as being in-ground and this should be understood to include a variety of possible different sub-surface structures that may be above or may surround a fluid conduit.

The one or more sensors 130, 131 may include sensors to detect fluid flow, fluid pressure, noise, temperature and water quality, for example. Sensors to detect other conditions may also be provided and more than one type of sensor may be used to 20 measure one type of condition (e.g. more than one water quality sensor may be used, such as conductivity, turbidity and/or chlorine content sensors). Depending on what information is desired to be gathered, a sub-set of those sensors may be comprised in installation 100. For example, it may be desired in some instances to measure fluid flow, fluid pressure and noise and in other instances to measure fluid flow, fluid pressure and water quality.

Using a number of the installations 100 at different locations around a particular water supply and/or drainage zone or multiple zones, measurement of water pressure and flow allows monitoring and management of water demand, as well as facilitating detection of leaks in the conduit network, in such a zone or zones. Monitoring of flow rates within the conduits allows real-time or near real-time assessment of water balance across a given area, such as a specified water supply and/or drainage zone or multiple such zones. For example, with this data, water flow into a zone can be monitored (e.g. using server 310 as described below) and a daily net inflow pattern established as “normal”, with the result that departures from this established norm can be flagged for further inspection because it may indicate a possible leak or burst. When flow data is combined with water pressure measurements, changes in water flow can be correlated with changes in water pressure to provide a stronger indication of the presence or absence of a leak. Acoustic noise sensors (for example sensing in the range from 0 to 5 kHz) can be used to further correlate the likely presence and leak location (i.e. roughly how far way the noise source is from the noise sensor). If one or more water quality sensors (e.g. chlorine content, turbidity and/or electrical conductivity) are used, this doesn't add to the leak detection capability but the position of the installation 100 may provide a convenient location to gather water quality information for water quality management and monitoring purposes.

Depending on the particular sensor function and/or type, one or more of the sensors 130, 131 may be inserted into the pressurised water main 135 (using normal “hot tapping” equipment and techniques), with possibly more than one sensor and/or condition being sensed by the inserted sensing apparatus. Other sensing apparatus may be coupled to an external wall 138 of fluid conduit 135, rather than by insertion of the equipment through conduit wall 138 into the fluid stream. For example, noise sensors may be magnetically coupled to the conduit wall 138. In some embodiments, sensor measurements conducted in relation to the fluid flowing in fluid conduit 135 may be conducted by sensors 130, 131 in relation to fluid drawn off in sample lines from conduit 135.

Only two sensors 130, 131 are shown and described herein, but it should be understood that only one sensor or more than two sensors, such as three, four or more sensors, may be provided. Additionally, each sensor may be provided in a separate sensor housing or multiple sensors may be housed within a single sensor housing. Further, more than one type of measurement may be obtained by each sensor.

Housing 110 has a lockable and optionally watertight solid sealing lid 112 to safely stow away the telemetry unit 120 and one or more sensors 130, 131 to avoid 30 vandalism, theft or accidental damage. The housing 110 may be of the form of a bottomless bin or may have a bottom surface with an opening through which cable 125 and/or sensors 130, 131 pass. Housing 110 and/or sealing lid 112 may be formed predominantly of a plastic, non-conductive material in order to not unduly hinder wireless transmission of messages from telemetry unit 120 or wireless receipt of messages by telemetry unit 120.

Housing 110 may be generally rectanguloid in some embodiments or generally cylindrical in other embodiments. The cylindrical form of housing 110 may be better able to withstand inward pressure on the housing from the surrounding earth. If housing 110 is generally cylindrical, it may still have a generally rectangular sealing lid 112. Alternatively, sealing lid 112 may be square, circular or other polygon-shaped. Lid 112 may be made of a strong road-grade solid plastic and fiber-glass composite material. Compared to a simple plastic lid, the composite lid material is thought to allow better transmission of radio signals through the lid 112 and to provide greater structural resistance to accidental damage, such as might be caused by a vehicle traversing over it.

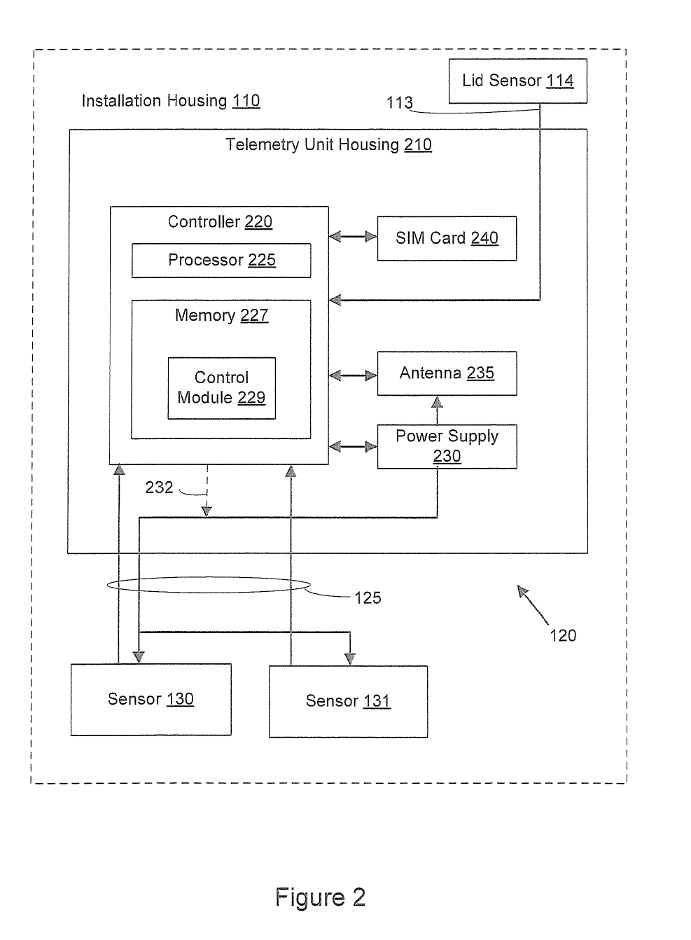

Housing 110 may also have a sensor 114 (FIGS. 1 and 2), such as a magnetic switch, positioned adjacent the lid to sense whether the lid is open. The lid position sensor 114 may be configured to provide a periodic status signal or to only provide an “open” or “closed” status signal to the telemetry unit 120 (via a suitable conductive electrical cable 113) when a change in status is detected (i.e. from “open” to “closed” or “closed” to “open”). Telemetry unit 120 optionally transmits a status message to remote server 310 (FIG. 3) when it receives a signal (i.e. a voltage or current change) from sensor 114 that indicates that a change in lid position status has been detected.

Telemetry unit 120 is preferably mounted to a side wall of housing 110, either directly or indirectly, so as to be supported thereby at a level below ground level. With such an arrangement, access to the internal space of housing 110, and to telemetry unit 120 in particular, can be readily achieved by maintenance personnel. The housing 110 may be sized to be sufficiently large to allow maintenance personnel to descend into the housing 110 for installation and/or maintenance of the one or more sensors 130, 131 and/or telemetry unit 120.

Referring also to FIG. 2, telemetry unit 120 is described in further detail. Telemetry unit 120 comprises a housing 210 that is fully waterproofed and pressure sealed to IP68 rating. Within the telemetry unit housing 210 there is a controller 220, a power supply 230, an antenna 235 and a subscriber identity module (SIM) card 240. Telemetry unit 120 may comprise additional components and/or circuitry (not shown) as judged by a person of ordinary skill in the art to be necessary or desirable in order to carry out the functions described herein. For example, telemetry unit 120 may comprise analogue to digital or digital to analogue conversion circuits (not shown), function testing circuits, digital signal processing components and/or display components to provide feedback to the user.

Controller 220 comprises a processor 225 and a memory 227. The memory 227 may comprise a combination of volatile and non-volatile computer readable storage and has sufficient capacity to store program code executable by processor 225 in order to perform appropriate processing functions as described herein. For example, processor 225 executes program code stored in memory 227 comprising a control module 229 to interact with SIM card 240 as necessary in order to transmit and/or receive messages 10 wirelessly using antenna 235. Further, control module 229 (executed by processor 225) controls the operation of the lid position sensor 114 (if necessary) and the one or more fluid condition sensors 130, 131, including switching power on and off to the sensors 114 (if necessary), 130, 131 and handles signals received from lid position sensor 114.

Power supply 230 comprises a long-life battery having the capacity to supply operating power to the telemetry unit 120 for a period of several years, for example up to about five years, before needing to be changed, assuming normal operation of telemetry unit 120 and normal operation of the power supply 230. The long life battery may comprise a lithium battery, for example. Power supply 230 is arranged to provide 20 power to controller 220, antenna 235 and other circuitry within telemetry unit 120, as appropriate. Power supply 230 also provides power to the one or more sensors 130, 131 via cable 125, responsive to power switching signals 232 from controller 220. If lid position sensor 114 is present, it may be powered (if necessary) by power supply 230 via cable 113 under the control of control module 229. However, for simplicity, lid position sensor 114 may comprise a simple switch circuit that consumes negligible power and may be left continuously on or periodically sampled.

Installation 100 does not require a concrete footing, fencing, above-ground electrical cabinetry, an external antenna or a mains power supply. Installation 100 need only have a hole prepared to receive the housing 110. Because the installation 100 is generally arranged to be even with ground level at its uppermost extent, it is less susceptible to inadvertent damage or vandalism.

Referring now to FIG. 3, a fluid monitoring system 300 comprising multiple installations 100 is described in further detail. Fluid monitoring system 300 comprises multiple installations 100 located in different geographic locations where fluid conduits within the fluid supply or drainage network are accessible through the ground or other sub-surface structure. The multiple installations 100 may be part of a single fluid supply and/or drainage zone within a larger fluid conduit network or may be spread across different zones and/or different networks. By way of example only, each zone may have one, two, three, four, five, six, seven, eight, nine, ten or more installations 100 located at different positions within the zone. Further, there may be more than ten, for example between ten and possibly hundreds of such installations 100 within a particular fluid conduit zone and/or network.

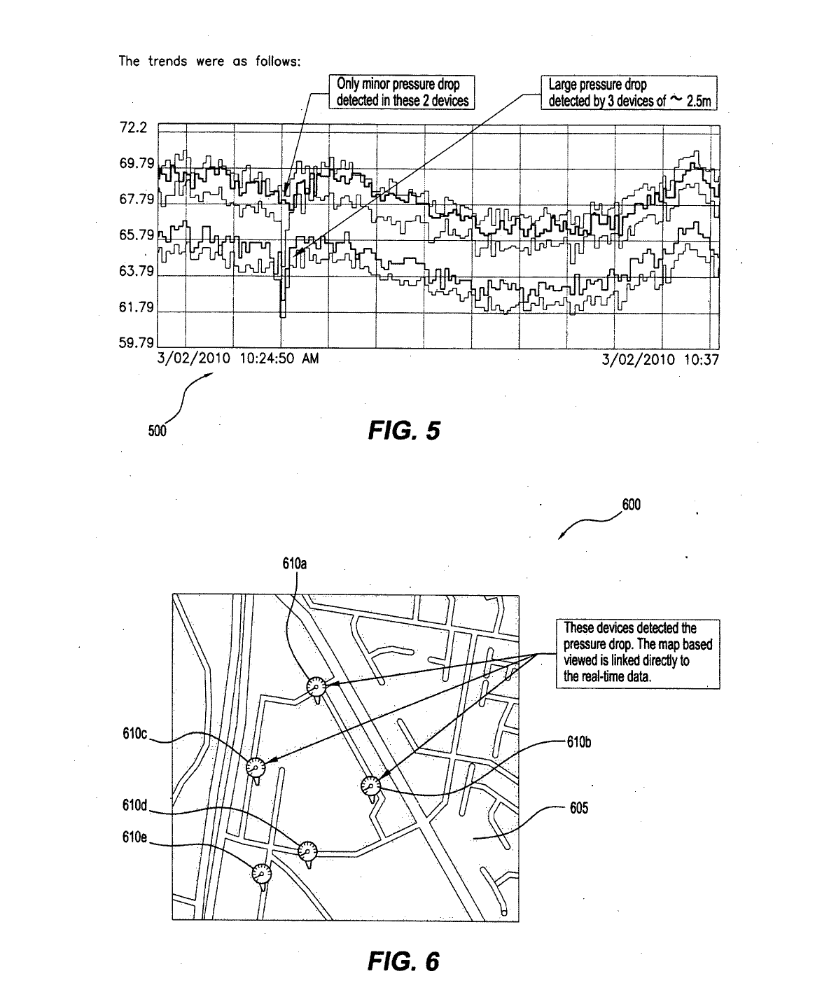

By way of example, FIG. 6 illustrates five separate installations 100 (indicated by icons 610a to 610e), located within part of a zone and viewable in relation to a map display 600 on a client device. The sensed pressure level of each of those installations 100 over a period of time is charted in the display 500 of FIG. 5. It can be seen from the charted pressure levels in display 500 that three of the installations 100 reported a significant pressure drop at a particular time, while the other two installations 100 indicated a relatively minor pressure drop at that time. When the locations of the installations 100 (corresponding to the locations of icons 610a, 610b and 610c) reporting the large pressure drop are viewed on the map display 600, a strong inference can be made about a likely geographic area of origin of the pressure drop, so that a possible leak in the pipe network can be investigated. Described embodiments allow the likely geographic area of origin of the pressure drop to be narrowed substantially, reducing time and cost to locate and repair any problem in the fluid suppy/drainage network.

Fluid monitoring system 300 further comprises one or more servers or server systems, referred to herein for convenience as server 310, at least one wired client device 320 and/or at least one mobile client device 325 and a data store 315. Server 310 may comprise, or be arranged as, a supervisory control and data acquisition (SCADA) server to receive data from installations 100 representative of the sensed conditions of fluid in the conduits 135 at various different locations. This data is received over a data network comprising suitable communications infrastructure that is at least partially wireless, such as a cellular network. For example, the telemetry units 120 of installations 100 may be configured to transmit data to server 310 using the GSM or GPRS/3G standards for mobile telephony or their technological successors. Thus, telemetry units 120 can communicate with server 310 by direct mobile data communication using available mobile telephony infrastructure, rather than using a series of hops and other infrastructure to transmit messages. Alternatively, lower power, shorter distance wireless communication techniques may be employed, for example where a local wireless data hub is in sufficient proximity to support wireless communication with the telemetry unit 120 within a nearby installation 100. However, more direct forms of communication from the telemetry units 120 to the server 310 are preferred for simplicity, speed and reliability.

Server 310 processes the data received from telemetry units 120 and stores it in data store 315 for subsequent retrieval as needed. Data store 315 may comprise any suitable data store, such as a local, external, distributed or discrete database. If the data received at server 310 from installations 100 indicates an alarm condition in any one or more of installations 100, server 310 accesses data store 315 to determine a pre-determined appropriate action to be taken in relation to the specific alarm condition, and then takes the appropriate action. The action to be taken may vary, depending on the installation 100, for example where some installations 100 may play a more critical monitoring role than others. Such actions may include, for example, sending one or more notifications, for example in the form of text messages and/or emails, to one or more of client devices 320, 325.

Regardless of whether an alarm condition is indicated by the data received at server 310 from installations 100, that data is processed and stored in data store 315 for later retrieval by a server process and/or at a request from a client device 320, 325. For example, server 310 may execute processes (based on program code stored in data store 315, for example), to perform trending and reporting functions to one or more client devices 320, 325. For example, server 310 may provide a client device 320 information to enable generation of a display 500 (FIG. 5) at client device 320 in response to a request for such information or automatically at regular intervals. Display 500 may chart historical and current data for one or more conditions of fluid in fluid conduits 135 at different locations over a period of time. For example, as shown in FIG. 5, display 500 may chart water pressure levels at different locations in the fluid network, such as may be indicated on a map 605 of display 600 (FIG. 6). The plotted pressure level data may indicate, for example as shown in display 500, that a substantial and sustained change in pressure has occurred at one or more sensor locations, but not at others, suggesting that there may be a leak at a point in the fluid conduit network in the vicinity of the installations 100 for which the pressure drop was reported. Thus, the map-based display 600 can be shown in conjunction with the historical plots of one or more conditions to correlate the probable location of an event of interest indicated by the plotted condition data. By using such information from displays 500 and 600, together with information about the known location of fluid supply conduits in the area, the likely origin of the suspected leak can be readily narrowed down to a small area, and possibly even a single conduit, which can be investigated relatively easily.

Displays 500 and 600 shown in FIGS. 5 and 6, respectively, may be generated at client device 320, 325 by a suitable software application executing on the client device 320, 325, such as a browser application executed by a processor of the client device 320, 325 according to program code stored in the local storage accessible to that processor.

In some embodiments, telemetry unit 120 may be enabled for bidirectional communication with server 310, so that firmware updates can be received and/or diagnostic testing can be performed remotely. In other embodiments, telemetry units 120 may be configured to only transmit data to server 310, without receiving data or messages in return.

Fluid monitoring system 300 thus comprises a series of installations 100 located around an area or zone for which fluid flow in a conduit network is desired to be monitored. These installations communicate with server 310, which in turn communicates with client devices 320, 325 as necessary. Server 310 also tracks and stores historical data received from the installations 100 and processes the incoming and historical data according to rules stored in data store 315 to determine whether certain pre-defined events of interest may be occurring. Such events may be complex events and may be defined in the stored rules as such.

In order to optimally monitor and manage a particular fluid supply or drainage zone or zones, system 300 may have installations 100 positioned around the outside of the zone to sense conditions at the respective main inlet conduits of the fluid supply network for that zone. Together with a (possibly lesser) number of installations 100 located at other positions within the zone, a minimal number of installations can be used to effectively monitor the zone. In such embodiments, the installations 100 around the outside of the zone are configured with sensors 130, 131 to monitor at least fluid flow and pressure and optionally also noise. The installations 100 that are at spaced locations more within the zone may be configured with sensors 130, 131 to monitor at least fluid pressure and water quality and optionally also fluid flow and/or noise. For example, the five installations 100 represented by icons 610a-e may be in a zone effectively defined roughly around the outside by the four installations 100 located at the positions of icons 610a, 610b, 610e and 610c, with the installation 100 located at the position of icon 610d being an inner-zone installation that has a different set of fluid conditions to sense (e.g including water quality).

In system 300, each installation 100 may be configured with a unique set of operational parameters (i.e. alarm levels, sensor sampling times, reporting intervals, etc.) and may have a specific set of sensors 130, 131, depending on its position and monitoring role within the system 300 as a whole.

In some embodiments of system 300, the telemetry unit 120 of each installation may be configured to send a message directly to a mobile communication device of an end user (i.e. client device 320, 325) when an alarm condition is determined by control module 229. This may be instead of or in addition to sending the message to the server 310.

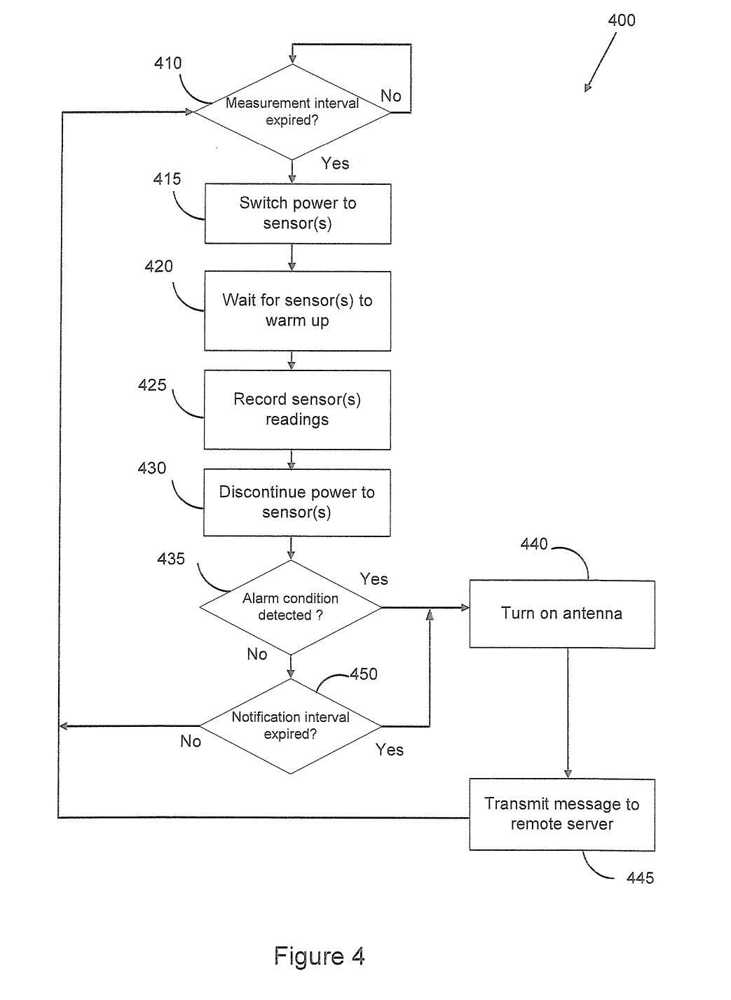

Referring now to FIG. 4, a method 400 of fluid monitoring by the telemetry unit 120 is shown and described in further detail. Method 400 is executed by the controller 220 of each telemetry unit 120 to control operation of the one or more sensors 130, 131 configured to sense conditions of fluid in each fluid conduit 135 with which the respective telemetry unit 120 is associated.

At 410, controller 220 waits a preconfigured time interval before switching power to the one or more sensors 130, 131 at 415. Once power is switched to the one or more sensors 130, 131 at 415, controller 220 waits a further period at 420 for the sensors to “warm-up”, for example by powering up their own internal electronics, 30 running their own operational diagnostics (if appropriate), and possibly indicating their operational state (e.g. properly operational or partially or fully non-operational).

Once the one or more sensors 130, 131 have warmed-up and, assuming they are operational, the sensors 130, 131 measure the relevant conditions and indicate at 425 a value of the condition they are configured to sense by providing a digital or analogue output signal to controller 220 via cable 125. The output signals from sensors 130, 131 are converted from analogue to digital signals, if appropriate, and then interpreted and stored by control module 229 in memory 227 for subsequent transmission to server 310.

At 430, once the sensor measurements (i.e. output signals) have been received from sensors 130, 131, control module 229 triggers switching control 232 to discontinue supply of power from power supply 230 to sensors 130, 131. Control module 229 then processes the data derived from the output signals to compare measured values to preconfigured alarm condition levels. If an alarm condition is detected, for example, because the sensed measurement exceeds or is equal to the alarm threshold for a particular sensor type, then control module 229 causes the antenna 235 to be turned on at 440 (for example, by causing power supply 230 to supply power to antenna 235) and an appropriate message to be transmitted to server 310 at 445. Steps 440 and 445 may also be performed to send a notification message where the lid sensor 114 detects the lid being opened or where some kind of fault in a sensor 130, 131 or telemetry unit 120 is detected. The message sent to server 310 may include an identifier of the telemetry unit, a time stamp, an indication of one or more sensed values (if appropriate) and an alarm or notification type, for example.

If no alarm condition is detected at 435 and no other condition requires immediate notification, then the control module 229 waits at 450 until a preconfigured notification interval expires before next turning on the antenna at 440 and sending a message at 445 to server 310 including a batch of measurements taken at the measurement intervals. Meanwhile, until the notification interval expires at 450, steps 410 to 435 may again be executed a number of times. The notification interval may be a period of hours, for example such as six, twelve, twenty four, or another number of hours, while the measurement interval may be in the order of a few minutes, for example such as one, two, three, four, five, ten, twenty, thirty, forty, fifty, sixty or more minutes.

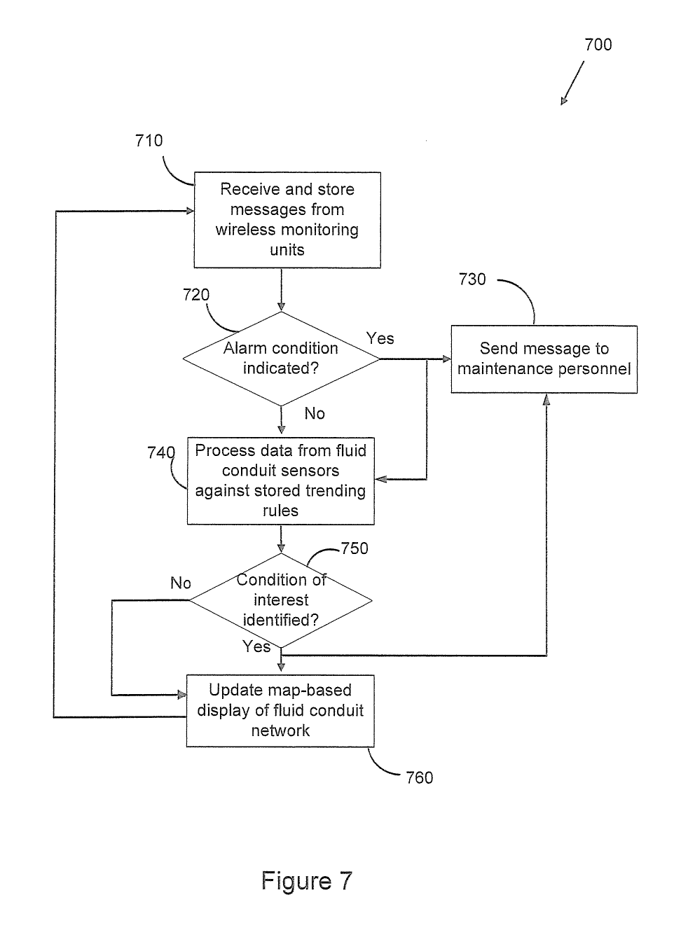

Referring now to FIG. 7, a method 700 of fluid monitoring is described in further detail. Method 700 assumes that a number of installations 100 have been provided at different locations to monitor different fluid conduits within a fluid supply/drainage zone and/or network. Method 700 additionally assumes that method 400 has been executed at each installation 100 and data regarding sensed measurements of fluid conditions has been processed and received from each telemetry unit 120. Method 700 is performed by server 310 by execution of program code that is stored in a memory accessible to server 310 (possibly including data store 315). The program code is executed by one or more processors operating in the server 310.

Method 700 begins at 710, when server 310 receives messages from wireless monitoring units 120 (i.e. following transmission of such messages at 445) over available wireless telecommunications infrastructure. The received messages are stored by server 310 in data store 315. At 720, server 310 determines whether any of the received messages indicates an alarm, fault or other special condition. If so, at 730 server 310 determines any predetermined actions to be taken, for example by accessing a look-up table stored in data store 315, and then initiates the predetermined action. In most cases, the action will involve sending a message to a stored email or mobile phone number of one or multiple supervisory maintenance or operational personnel in order to immediately notify them of the alarm condition and prompt them to take action as appropriate. However, other actions or further processing may be performed in some instances. The look-up table may store telephone and email contact details of responsible supervisory personnel, as well as escalation rules in case of a failure by any such personnel to respond to the message.

If no alarm, fault or other special condition is indicated, then at 740, data from the received messages regarding the conditions sensed by the fluid conduit sensors is processed according to trending rules and/or reporting rules stored in data store 315 or in a memory local to server 310 to identify one or more conditions of interest at 750. For example, a stored rule may be set up to establish that a predetermined change of noise level over a period of time, such as a week, that does not actually trigger an alarm condition may nevertheless be a condition of interest. As another example, a significant change in water usage patterns on a day to day, week to week or month to month basis may indicate a condition of interest.

In some cases, theft of water from a water hydrant may occur and, in the absence of any data as to pressure or flow in the relevant part of the fluid supply network, such theft may be difficult or impossible to detect. Thus, a significant reduction in water flow or pressure in a particular section of the fluid conduit network that is then restored after a half an hour or an hour, for example, may be detectable as a condition of interest that might indicate theft of water from that part of the fluid network, rather than a leak which would show a sustained water pressure or flow drop. Such a scenario may also trigger an alarm condition from the nearby monitoring installation 100.

In a further example, server 310 may check whether authorised maintenance is scheduled to occur for a particular installation 100 in response to receiving a notification message indicating that the lid 112 is open. If no maintenance is scheduled, then it may be inferred that the installation 100 has suffered damage or vandalism, which may be treated as a condition of interest or a special condition to trigger a notification message to appropriate personnel.

If a condition of interest is identified at 750 following processing of the data from the sensors, then a suitable message is sent to maintenance and/or operational personnel at 730, either by email or short messaging service (SMS), or other form of prompt electronically transmissible message that is suitable for emergency notification. Whether or not a condition of interest is identified at 750, server 310 may cause map-based displays 600 or trending charts 500 to be updated with new data, as appropriate, assuming that such displays are active on a client device 320 or 325.

The acts of method 700 may be repeatedly performed on a continual basis or 20 periodically as messages are received from various telemetry units 120 in the field. Server 310 may also be used to wirelessly download updated firmware and/or perform diagnostic testing on the telemetry units 120.

Some variation and/or modification may be used to the described embodiments without departing from the scope of the invention as broadly described. The described embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

1. A fluid monitoring system, comprising:
a housing positioned in-ground above a buried fluid conduit, the housing having a lockable access hatch to allow access to an internal volume of the housing from surface level;
at least one sensor accessible through the internal volume and arranged to sense at least one condition of fluid in the fluid conduit; and
a wireless telemetry unit supported in the housing and coupled to receive output signals from the at least one sensor in relation to the at least one condition.

2. The system of claim 1, wherein the wireless telemetry unit is free of reliance on an external power source.

3. The system of claim 1, wherein the wireless telemetry unit is arranged to wirelessly transmit data corresponding to the output signals to a remote network node.

4. The system of claim 1, wherein the housing comprises substantially non-conductive material to allow transmission of data from the wireless telemetry unit while the access hatch is closed.

5. The system of claim 1, wherein the lockable access hatch comprises a solid lid formed of a strong composite material that minimally attenuates radio wave transmissions passing therethrough.

6. The system of claim 1, wherein the housing is formed at least predominantly of a substantially rigid plastic material.

7. The system of claim 1, wherein the access hatch bars access to the internal volume when closed and locked.

8. The system of claim 1, wherein the telemetry unit has an antenna and the telemetry unit is mounted to the housing so that the antenna is positioned below the access hatch and does not extend through the access hatch.

9. The system of claim 1, further comprising a lid position sensor disposed in the housing and communicatively coupled to the telemetry unit to provide a signal thereto to indicate a sensed position of a lid of the housing.

10. The system of claim 1, wherein the at least one sensor is arranged to sense at least one of fluid flow, fluid pressure, noise and water quality.

11. The system of claim 10, wherein the at least one sensor is arranged to sense fluid flow, fluid pressure and noise.

12. The system of claim 10, wherein the at least one sensor is arranged to sense fluid flow, fluid pressure and water quality.

13. The system of claim 1, wherein the telemetry unit comprises a controller to control operation of the at least one sensor.

14. The system of claim 13, wherein the telemetry unit is configured to periodically cause the at least one sensor to turn on, generate an output signal corresponding to each sensed at least one condition and then turn off.

15. The system of claim 13, wherein the telemetry unit comprises a power source to power the controller and to power the at least one sensor.

16. The system of claim 13, wherein the controller is configured to compare sensor values corresponding to the received output signals to an expected range of values for each sensor and to send an alarm message to a remote network node if the sensor values for at least one sensor fall outside the expected range for that sensor.

17. The system of claim 1, wherein the telemetry unit comprises a long-life battery.

18. The system of claim 17, wherein the long-life battery has sufficient stored energy to support normal operation of the telemetry unit for several years.

19. The system of claim 1, wherein the telemetry unit and the at least one sensor are configured for low power consumption.

20. A fluid monitoring system, comprising:
a plurality of in-ground installations, each installation comprising a fluid monitoring system according to claim 1; and
a server to receive data representative of sensed fluid conditions from the wireless telemetry units of respective installations via a wireless network.

21. The system of claim 20, wherein the installations are positioned within a water supply and drainage zone so that monitoring by the server of sensed fluid conditions at each installation allows identification of one or more conditions of interest within the water supply and drainage zone.

22. The system of claim 21, wherein the at least one sensor of at least one of the installations is arranged to sense at least one condition of fluid that is different from the at least one condition of fluid arranged to be sensed by the at least one sensor of another of the installations.

23. The system of claim 21, wherein one of the installations is positioned at each main inlet conduit of the supply and drainage zone.

24. The system of claim 21, wherein some of the installations are positioned around an outside of the supply and drainage zone and fewer of the installations are positioned in inner areas of the supply and drainage zone.

25. A fluid monitoring system, comprising:
a plurality of sensors positioned to sense conditions of at least one buried fluid conduit;
a plurality of wireless telemetry units, each telemetry unit positioned within an in-ground housing proximate at least one of the plurality of sensors and coupled thereto to receive output signals corresponding to sensed conditions; and
a server to communicate with the wireless telemetry units via a wireless network, to receive data representative of the sensed conditions.

26. The system of claim 20, wherein each wireless telemetry unit is free of reliance on an external power source.

27. The system of claim 20, wherein the server comprises program code to process the received data representative of the sensed conditions according to a set of stored rules accessible to the server.

28. The system of claim 27, wherein processing of the received data includes accessing stored historical data received from the wireless telemetry units and determining whether an event of interest appears to be occurring or is likely to occur in relation to the at least one conduit.

29. The system of claim 20, wherein the server comprises an interface component to communicate with a client device in relation to the received data representative of the sensed conditions.

30. A fluid monitoring method, comprising:
providing a wireless telemetry unit in-ground above a buried fluid conduit, the wireless telemetry unit coupled to receive output signals from at least one sensor arranged to sense at least one condition of fluid in the fluid conduit, the at least one sensor relying on power from the wireless telemetry unit;
selectively providing power from the wireless telemetry unit to the at least one sensor;
receiving at the wireless telemetry unit output signals from the at least one sensor indicative of at least one fluid condition in the fluid conduit; and
discontinuing power from the wireless telemetry unit to the at least one sensor after the receiving.

31. The method of claim 30, wherein the providing power is selected to occur at predetermined intervals.

32. The method of claim 30, wherein the wireless telemetry unit is free of reliance on an external power source.

33. The method of claim 30, further comprising transmitting a message from the wireless telemetry unit to a remote server, the message containing data based on the output signals from the at least one sensor.

34. The method of claim 30, further comprising waiting a predetermined time between the providing power and the receiving output signals to allow the at least one sensor to become ready to provide the output signals.

35. The method of claim 30, wherein the wireless telemetry unit is positioned in an in-ground lockable housing accessible from surface level.

36. The method of claim 30, further comprising the wireless telemetry unit processing the output signals to determine whether an alarm condition exists.

37. The method of claim 36, further comprising the wireless telemetry unit sending an alarm message to a remote network node if an alarm condition is determined to exist.

38. A fluid monitoring method, comprising:
receiving at a server messages from a plurality of wireless telemetry units communicatively coupled to a plurality of sensors, at least one sensor coupled to each wireless telemetry unit being positioned to sense a condition of at least one buried fluid conduit, the messages comprising data indicative of one or more of the sensed conditions; and
processing the message data to infer trends and/or determine an event of interest in relation to the at least one buried fluid conduit.

39. The method of claim 38, further comprising:
processing the message data to determine whether an alarm, fault or special condition is indicated in relation to one or more conditions of the at least one buried fluid conduit;
transmitting a notification message to at least one predetermined notification recipient if the server determines that an alarm, fault or special condition is indicated.

40. The method of claim 38, wherein the event of interest comprises a fluid theft or a fluid leak.

41.-44. (canceled)
